(19) United States
(12) Patent Application Publication
(10) Pub. No.: US 2026/0236347 A1
(43) Pub. Date: Aug. 13, 2026

(54) DECODE CONTROL METHOD, MEMORY STORAGE DEVICE, AND MEMORY CONTROL CIRCUIT UNIT

(71) Applicant: PHISON ELECTRONICS CORP., Miaoli (TW)

(72) Inventors: Yu-Hsiang Lin, Yunlin County (TW); Bo Lun Huang, Tainan City (TW)

(73) Assignee: PHISON ELECTRONICS CORP., Miaoli (TW)

(21) Appl. No.: 19/177,655

(22) Filed: Apr. 14, 2025

(30) Foreign Application Priority Data
Feb. 10, 2025 (TW) 114104842

(51) Int. Cl. G06F 11/10

(52) U.S. Cl. CPC G06F 11/1048; G06F 11/1068

(57) ABSTRACT

A decode control method, a memory storage device, and a memory control circuit unit are provided. The decode control method includes the following step. in response to a first decoding operation executed according to write data and first parity data failing, reading second parity data; executing a second decoding operation according to the second parity data; in response to the second decoding operation being successful, increasing a log likelihood ratio corresponding to the second parity data; and executing a third decoding operation according to the write data, the first parity data, and the second parity data.

### CROSS-REFERENCE TO RELATED APPLICATION

This application claims the priority benefit of Taiwan application serial no. 114104842, filed on Feb. 10, 2025. The entirety of the above-mentioned patent application is hereby incorporated by reference herein and made a part of this specification.

### BACKGROUND

### Technical Field

The disclosure relates to a memory management technology, and more particularly to a decode control method, a memory storage device, and a memory control circuit unit.

### Description of Related Art

Portable electronic devices such as mobile phones and notebook computers have grown rapidly in the past few years, which has led to a rapid increase in consumer demand for storage media. As the rewritable non-volatile memory module (for example, a flash memory) has characteristics such as non-volatile data, power saving, small volume, and no mechanical structure, the rewritable non-volatile memory module is very suitable for being built into various portable electronic devices exemplified above.

Generally speaking, in order to maintain reliability of data, the data is first encoded to generate a corresponding error correcting code before being stored in the rewritable non-volatile memory module. Then, the error correcting code is stored in the rewritable non-volatile memory module along with the corresponding data. Thereafter, when the data is read from the rewritable non-volatile memory module, the corresponding error correcting code may be used to correct possible errors in the data. How to improve the ability of executing a decoding operation according to the data read from the rewritable non-volatile memory module is one of the key topics that persons skilled in the art focus on.

### SUMMARY

The disclosure provides a decode control method, a memory storage device, and a memory control circuit unit, which may improve decoding ability.

An exemplary embodiment of the disclosure provides a decode control method for a rewritable non-volatile memory module, and the decode control method includes the following steps. In response to a first decoding operation executed according to write data and first parity data failing, second parity data is read. A second decoding operation is executed according to the second parity data. In response to the second decoding operation being successful, a log likelihood ratio corresponding to the second parity data is increased. A third decoding operation is executed according to the write data, the first parity data, and the second parity data.

In an exemplary embodiment of the disclosure, the decode control method further includes the following step. In response to the first decoding operation failing, a log likelihood ratio corresponding to the write data and a log likelihood ratio corresponding to the first parity data are reduced.

In an exemplary embodiment of the disclosure, the decode control method further includes the following steps. In response to the third decoding operation failing, third parity data is read. A fourth decoding operation is executed according to the third parity data. In response to the fourth decoding operation being successful, a log likelihood ratio corresponding to the third parity data is increased. A fifth decoding operation is executed according to the write data, the first parity data, the second parity data, and the third parity data.

In an exemplary embodiment of the disclosure, the decode control method further includes the following steps. Decoding results of the first decoding operation and the second decoding operation are recorded. The log likelihood ratio is adjusted according to the decoding result.

An exemplary embodiment of the disclosure provides a decode control method for a rewritable non-volatile memory module, and the decode control method includes the following step. A decoding operation is executed according to serial data. In the decoding operation, the decoding operation is executed on a first part of the serial data using a first log likelihood ratio, and the decoding operation is executed on a second part of the serial data using a second log likelihood ratio. The first log likelihood ratio is derived from a first lookup table, and the second log likelihood ratio is derived from a second lookup table. Before performing the decoding operation, the second part has been decoded and decoding is successful.

In an exemplary embodiment of the disclosure, before performing the decoding operation, the first part has been decoded and decoding fails.

In an exemplary embodiment of the disclosure, the first part and the second part are read from different physical units.

An exemplary embodiment of the disclosure further provides a memory storage device including a connection interface unit, a rewritable non-volatile memory module, and a memory control circuit unit. The connection interface unit is coupled to a host system. The memory control circuit unit is coupled to the connection interface unit and the rewritable non-volatile memory module. In response to a first decoding operation executed according to write data and first parity data failing, the memory control circuit unit is configured to read second parity data. In response to a second decoding operation being successful, the memory control circuit unit is further configured to increase a log likelihood ratio corresponding to the second parity data. The memory control circuit unit includes a decoding circuit. The decoding circuit is configured to execute the second decoding operation according to the second parity data. The decoding circuit is further configured to execute a third decoding operation according to the write data, the first parity data, and the second parity data.

In an exemplary embodiment of the disclosure, in response to the first decoding operation failing, the memory control circuit unit is further configured to reduce a log likelihood ratio corresponding to the write data and a log likelihood ratio corresponding to the first parity data.

In an exemplary embodiment of the disclosure, in response to the third decoding operation failing, the memory control circuit unit is further configured to read third parity data. In response to a fourth decoding operation being successful, the memory control circuit unit is further configured to increase a log likelihood ratio corresponding to the third parity data. The decoding circuit is further configured to execute the fourth decoding operation according to the third parity data. The decoding circuit is further configured to execute a fifth decoding operation according to the write data, the first parity data, the second parity data, and the third parity data.

In an exemplary embodiment of the disclosure, the memory control circuit unit is further configured to record decoding results of the first decoding operation and the second decoding operation. The memory control circuit unit is further configured to adjust the log likelihood ratio according to the decoding result.

An exemplary embodiment of the disclosure further provides a memory storage device including a connection interface unit, a rewritable non-volatile memory module, and a memory control circuit unit. The connection interface unit is coupled to a host system. The memory control circuit unit is coupled to the connection interface unit and the rewritable non-volatile memory module. The memory control circuit unit includes a decoding circuit. The decoding circuit is configured to execute a decoding operation according to serial data. In the decoding operation, the decoding circuit is further configured to execute the decoding operation on a first part of the serial data using a first log likelihood ratio, and execute the decoding operation on a second part of the serial data using a second log likelihood ratio. The first log likelihood ratio is derived from a first lookup table, and the second log likelihood ratio is derived from a second lookup table. Before performing the decoding operation, the second part has been decoded and decoding is successful.

An exemplary embodiment of the disclosure further provides a memory control circuit unit for controlling a rewritable non-volatile memory module. The memory control circuit unit includes a host interface, a memory interface, a decoding circuit, and a memory management circuit. The host interface is coupled to a connection interface unit. The memory interface is coupled to the rewritable non-volatile memory module. The memory management circuit is coupled to the host interface, the memory interface, and the decoding circuit. In response to a first decoding operation executed according to write data and first parity data failing, the memory management circuit is configured to read second parity data. In response to a second decoding operation being successful, the memory management circuit is further configured to increase a log likelihood ratio corresponding to the second parity data. The decoding circuit is configured to execute the second decoding operation according to the second parity data. The decoding circuit is further configured to execute a third decoding operation according to the write data, the first parity data, and the second parity data.

In an exemplary embodiment of the disclosure, in response to the first decoding operation failing, the memory management circuit is further configured to reduce a log likelihood ratio corresponding to the write data and a log likelihood ratio corresponding to the first parity data.

In an exemplary embodiment of the disclosure, in response to the third decoding operation failing, the memory management circuit is further configured to read third parity data. In response to a fourth decoding operation being successful, the memory management circuit is further configured to increase a log likelihood ratio corresponding to the third parity data. The decoding circuit is further configured to execute the fourth decoding operation according to the third parity data. The decoding circuit is further configured to execute a fifth decoding operation according to the write data, the first parity data, the second parity data, and the third parity data.

In an exemplary embodiment of the disclosure, the memory management circuit is further configured to record decoding results of the first decoding operation and the second decoding operation. The memory management circuit is further configured to adjust the log likelihood ratio according to the decoding result.

An exemplary embodiment of the disclosure further provides a memory control circuit unit for controlling a rewritable non-volatile memory module. The memory control circuit unit includes a host interface, a memory interface, a decoding circuit, and a memory management circuit. The host interface is coupled to a connection interface unit. The memory interface is coupled to the rewritable non-volatile memory module. The memory management circuit is coupled to the host interface, the memory interface, and the decoding circuit. The decoding circuit is configured to execute a decoding operation according to serial data. In the decoding operation, the decoding circuit is further configured to execute the decoding operation on a first part of the serial data using a first log likelihood ratio, and execute the decoding operation on a second part of the serial data using a second log likelihood ratio. The first log likelihood ratio is derived from a first lookup table, and the second log likelihood ratio is derived from a second lookup table. Before performing the decoding operation, the second part has been decoded and decoding is successful.

Based on the above, the decode control method, the memory storage device, and the memory control circuit unit of the disclosure may dynamically adjust the reliability information (that is, the log likelihood ratio) according to the decoding result to improve decoding ability.

### BRIEF DESCRIPTION OF THE DRAWINGS

FIG. 1 is a schematic diagram of a host system, a memory storage device, and an input/output (I/O) device according to an exemplary embodiment of the disclosure.

FIG. 2 is a schematic diagram of a host system, a memory storage device, and an I/O device according to an exemplary embodiment of the disclosure.

FIG. 3 is a schematic diagram of a host system and a memory storage device according to an exemplary embodiment of the disclosure.

FIG. 4 is a schematic block diagram of a memory storage device according to an exemplary embodiment of the disclosure.

FIG. 5 is a schematic block diagram of a memory control circuit unit according to an exemplary embodiment of the disclosure.

FIG. 6 is a schematic diagram of managing a rewritable non-volatile memory module according to an exemplary embodiment of the disclosure.

FIG. 7 is a schematic diagram of a threshold voltage distribution of a first physical unit and reading the first physical unit using multiple read voltage levels according to an exemplary embodiment of the disclosure.

FIG. 8 is a schematic diagram of a first lookup table corresponding to a first physical unit according to an exemplary embodiment of the disclosure.

FIG. 9 is a schematic diagram of a decoding process according to an exemplary embodiment of the disclosure.

FIG. 10 is a flowchart of a decode control method according to an exemplary embodiment of the disclosure.

FIG. 11 is a flowchart of a decode control method according to an exemplary embodiment of the disclosure.

### DESCRIPTION OF THE EMBODIMENTS

Generally speaking, a memory storage device (also referred to as a memory storage system) includes a rewritable non-volatile memory module and a controller (also referred to as a control circuit). The memory storage device may be used together with a host system, so that the host system may write data to the memory storage device or read data from the memory storage device.

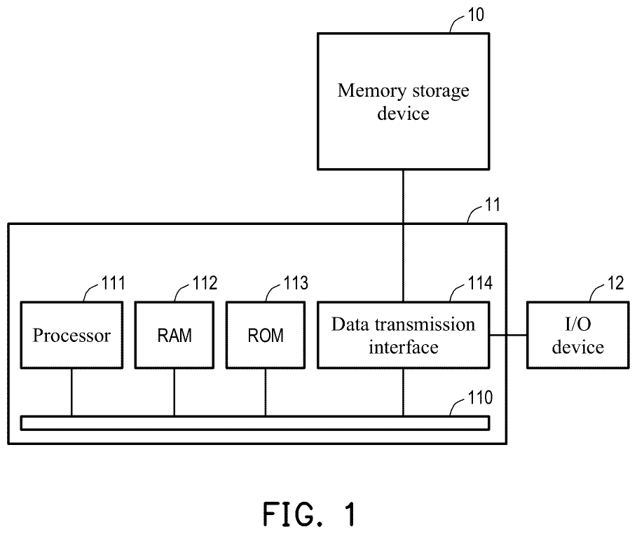

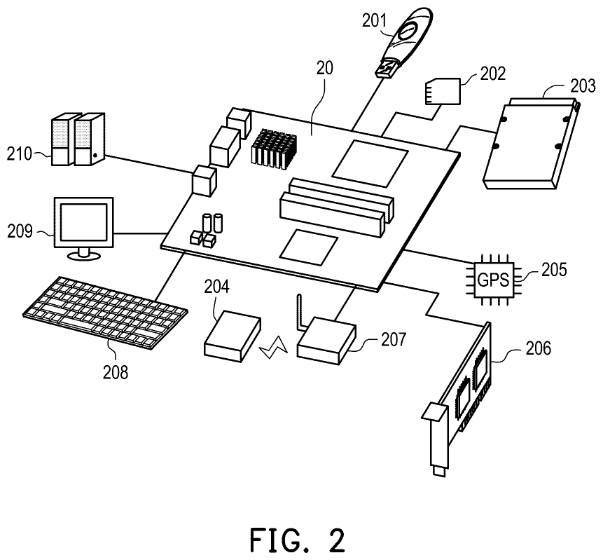

FIG. 1 is a schematic diagram of a host system, a memory storage device, and an input/output (I/O) device according to an exemplary embodiment of the disclosure. FIG. 2 is a schematic diagram of a host system, a memory storage device, and an I/O device according to an exemplary embodiment of the disclosure.

Please refer to FIG. 1 and FIG. 2. A host system 11 may include a processor 111, a random access memory (RAM) 112, a read only memory (ROM) 113, and a data transmission interface 114. The processor 111, the random access memory 112, the read only memory 113, and the data transmission interface 114 may be coupled to a system bus 110.

In an exemplary embodiment, the host system 11 may be coupled to a memory storage device 10 through the data transmission interface 114. For example, the host system 11 may store data in the memory storage device 10 or read data from the memory storage device 10 via the data transmission interface 114. In addition, the host system 11 may be coupled to the I/O device 12 through the system bus 110. For example, the host system 11 may send an output signal to the I/O device 12 or receive an input signal from the I/O device 12 via the system bus 110.

In an exemplary embodiment, the processor 111, the random access memory 112, the read only memory 113, and the data transmission interface 114 may be disposed on a motherboard 20 of the host system 11. The number of the data transmission interface 114 may be one or more. Through the data transmission interface 114, the motherboard 20 may be coupled to the memory storage device 10 via a wired or wireless manner.

In an exemplary embodiment, the memory storage device 10 may be, for example, a flash drive 201, a memory card 202, a solid state drive (SSD) 203, or a wireless memory storage device 204. The wireless memory storage device 204 may be, for example, a near field communication (NFC) memory storage device, a WiFi memory storage device, a Bluetooth memory storage device, a Bluetooth low energy memory storage device (for example, iBeacon), or other memory storage devices based on various wireless communication technologies. In addition, the motherboard 20 may also be coupled to various I/O devices such as a global positioning system (GPS) module 205, a network interface card 206, a wireless transmission device 207, a keyboard 208, a screen 209, and a speaker 210 through the system bus 110. For example, in an exemplary embodiment, the motherboard 20 may access the wireless memory storage device 204 through the wireless transmission device 207.

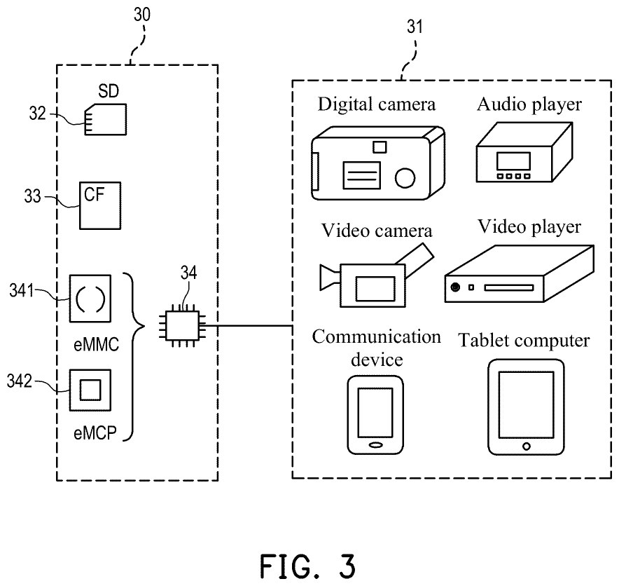

In an exemplary embodiment, the host system 11 is a computer system. In an exemplary embodiment, the host system 11 may be any system that may substantially cooperate with a memory storage device to store data. In an exemplary embodiment, the memory storage device 10 and the host system 11 may respectively include a memory storage device 30 and a host system 31 of FIG. 3.

FIG. 3 is a schematic diagram of a host system and a memory storage device according to an exemplary embodiment of the disclosure. Please refer to FIG. 3. The memory storage device 30 may be used in conjunction with the host system 31 to store data. For example, the host system 31 may be a system such as a digital camera, a video camera, a communication device, an audio player, a video player, and a tablet computer. For example, the memory storage device 30 may be various non-volatile memory storage devices, such as a secure digital (SD) card 32, a compact flash (CF) card 33, and an embedded storage device 34, used by the host system 31. The embedded storage device 34 includes various embedded storage devices, such as an embedded multi media card (eMMC) 341 and/or an embedded multi chip package (eMCP) storage device 342, in which a memory module is directly coupled onto a substrate of a host system.

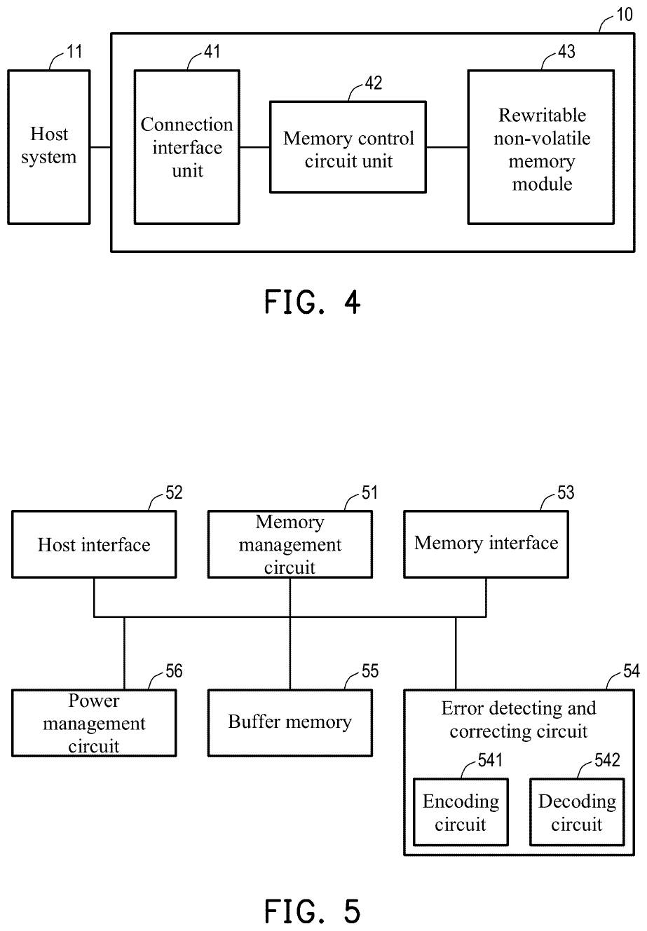

FIG. 4 is a schematic block diagram of a memory storage device according to an exemplary embodiment of the disclosure. Please refer to FIG. 4. The memory storage device 10 includes a connection interface unit 41, a memory control circuit unit 42, and a rewritable non-volatile memory module 43.

The connection interface unit 41 is configured to couple to the host system 11. The memory storage device 10 may communicate with the host system 11 via the connection interface unit 41. In an exemplary embodiment, the connection interface unit 41 is compatible with the peripheral component interconnect (PCI) express standard. In an exemplary embodiment, the connection interface unit 41 may also conform to the serial advanced technology attachment (SATA) standard, the parallel advanced technology attachment (PATA) standard, the Institute of Electrical and Electronic Engineers (IEEE) 1394 standard, the universal serial bus (USB) standard, the SD interface standard, the ultra high speed-I (UHS-I) interface standard, the ultra high speed-II (UHS-II) interface standard, the memory stick (MS) interface standard, the MCP interface standard, the MMC interface standard, the eMMC interface standard, the universal flash storage (UFS) interface standard, the eMCP interface standard, the CF interface standard, the integrated device electronics (IDE) standard, or other suitable standards. The connection interface unit 41 and the memory control circuit unit 42 may be packaged in one chip, or the connection interface unit 41 may be arranged outside a chip including the memory control circuit unit 42.

The memory control circuit unit 42 is coupled to the connection interface unit 41 and the rewritable non-volatile memory module 43. The memory control circuit unit 42 is configured to execute multiple logic gates or control commands implemented in the form of hardware or the form of firmware and perform operations such as data writing, reading, and erasing in the rewritable non-volatile memory module 43 according to a command of the host system 11.

The rewritable non-volatile memory module 43 is configured to store data written by the host system 11. The rewritable non-volatile memory module 43 may include a single level cell (SLC) NAND flash memory module (that is, a flash memory module that may store 1 bit in a memory cell), a multi level cell (MLC) NAND flash memory module (that is, a flash memory module that may store 2 bits in a memory cell), a triple level cell (TLC) NAND flash memory module (that is, a flash memory module that may store 3 bits in a memory cell), a quad level cell (QLC) NAND flash memory module (that is, a flash memory module that may store 4 bits in a memory cell), other flash memory modules, or other memory modules with the same characteristics.

Each memory cell in the rewritable non-volatile memory module 43 stores one or more bits with changes in voltage (hereinafter also referred to as a threshold voltage). Specifically, there is a charge trapping layer between a control gate and a channel of each memory cell. Through applying a write voltage to the control gate, the number of electrons in the charge trapping layer may be changed, thereby changing the threshold voltage of the memory cell. The operation of changing the threshold voltage of the memory cell is also referred to as “writing data to the memory cell” or “programming the memory cell”. As the threshold voltage changes, each memory cell in the rewritable non-volatile memory module 43 has multiple storage statuses. It is possible to judge which storage status a memory cell belongs to through applying a read voltage, so as to obtain one or more bits stored in the memory cell.

In an exemplary embodiment, the memory cells of the rewritable non-volatile memory module 43 may constitute multiple physical programming units, and the physical programming units may constitute multiple physical erasing units. Specifically, the memory cells on the same word line may form one or more physical programming units. If one memory cell may store more than 2 bits, the physical programming units on the same word line may be at least classified into a lower physical programming unit and an upper physical programming unit. For example, a least significant bit (LSB) of a memory cell belongs to the lower physical programming unit, and a most significant bit (MSB) of a memory cell belongs to the upper physical programming unit. Generally speaking, in the MLC NAND flash memory, the write speed of the lower physical programming unit is greater than the write speed of the upper physical programming unit and/or the reliability of the lower physical programming unit is higher than the reliability of the upper physical programming unit.

In an exemplary embodiment, the physical programming unit is the smallest unit of programming. That is, the physical programming unit is the smallest unit of writing data. For example, the physical programming unit may be a physical page or a physical sector. If the physical programming unit is a physical page, the physical programming units may include a data bit area and a redundancy bit area. The data bit area includes multiple physical sectors for storing user data, and the redundancy bit area is configured to store system data (for example, management data such as an error correcting code). In an exemplary embodiment, the data bit area includes 32 physical sectors, and the size of one physical sector is 512 bytes (B). However, in other exemplary embodiments, the data bit area may also include 8, 16, more, or less physical sectors, and the size of each physical sector may also be greater or smaller. On the other hand, the physical erasing unit is the smallest unit of erasure. That is, each physical erasing unit includes the smallest number of memory cells to be erased together. For example, the physical erasing unit is a physical block.

FIG. 5 is a schematic block diagram of a memory control circuit unit according to an exemplary embodiment of the disclosure. Please refer to FIG. 5. The memory control circuit unit 42 includes a memory management circuit 51, a host interface 52, and a memory interface 53.

The memory management circuit 51 is configured to control the overall operation of the memory control circuit unit 42. Specifically, the memory management circuit 51 has multiple control commands, and when the memory storage device 10 is operating, the control commands are executed to perform operations such as data writing, reading, and erasing. The following description of the operation of the memory management circuit 51 is equivalent to the description of the operation of the memory control circuit unit 42.

In an exemplary embodiment, the control commands of the memory management circuit 51 are implemented in the form of firmware. For example, the memory management circuit 51 has a microprocessor unit (not shown) and a read only memory (not shown), and the control commands are burnt into the read only memory. When the memory storage device 10 is operating, the control commands are executed by the microprocessor unit to perform operations such as data writing, reading, and erasing.

In an exemplary embodiment, the control commands of the memory management circuit 51 may also be stored in a specific region (for example, a system area dedicated to storing system data in a memory module) of the rewritable non-volatile memory module 43 in the form of program codes. In addition, the memory management circuit 51 has a microprocessor unit (not shown), a read only memory (not shown), and a random access memory (not shown). In particular, the read only memory has a boot code, and when the memory control circuit unit 42 is enabled, the microprocessor unit first executes the boot code to load the control commands stored in the rewritable non-volatile memory module 43 into the random access memory of the memory management circuit 51. After that, the microprocessor unit runs the control commands to perform operations such as data writing, reading, and erasing.

In an exemplary embodiment, the control commands of the memory management circuit 51 may also be implemented in the form of hardware. For example, the memory management circuit 51 includes a microcontroller, a memory cell management circuit, a memory write circuit, a memory read circuit, a memory erase circuit, and a data processing circuit. The memory cell management circuit, the memory write circuit, the memory read circuit, the memory erase circuit, and the data processing circuit are coupled to the microcontroller. The memory cell management circuit is configured to manage a memory cell or a memory cell group of the rewritable non-volatile memory module 43. The memory write circuit is configured to issue a write command sequence to the rewritable non-volatile memory module 43 to write data to the rewritable non-volatile memory module 43. The memory read circuit is configured to issue a read command sequence to the rewritable non-volatile memory module 43 to read data from the rewritable non-volatile memory module 43. The memory erase circuit is configured to issue an erase command sequence to the rewritable non-volatile memory module 43 to erase data from the rewritable non-volatile memory module 43. The data processing circuit is configured to process data to be written to the rewritable non-volatile memory module 43 and data read from the rewritable non-volatile memory module 43. The write command sequence, the read command sequence, and the erase command sequence may each include one or more program codes or command codes and are configured to instruct the rewritable non-volatile memory module 43 to execute corresponding operations such as writing, reading, and erasing. In an exemplary embodiment, the memory management circuit 51 may also issue other types of command sequences to the rewritable non-volatile memory module 43 to instruct to execute corresponding operations.

The host interface 52 is coupled to the memory management circuit 51. The memory management circuit 51 may communicate with the host system 11 through the host interface 52. The host interface 52 may be configured to obtain and identify commands and data from the host system 11. For example, the commands and the data from the host system 11 may be sent to the memory management circuit 51 through the host interface 52. In addition, the memory management circuit 51 may send the data to the host system 11 through the host interface 52. In the exemplary embodiment, the host interface 52 is compatible with the PCI express standard. However, it must be understood that the disclosure is not limited thereto. The host interface 52 may also be compatible with the SATA standard, the PATA standard, the IEEE 1394 standard, the USB standard, the SD standard, the UHS-I standard, the UHS-II standard, the MS standard, the MMC standard, the eMMC standard, the UFS standard, the CF standard, the IDE standard, or other suitable data transmission standards.

The memory interface 53 is coupled to the memory management circuit 51 and is configured to access the rewritable non-volatile memory module 43. For example, the memory management circuit 51 may access the rewritable non-volatile memory module 43 through the memory interface 53. In other words, data to be written to the rewritable non-volatile memory module 43 is converted into a format acceptable by the rewritable non-volatile memory module 43 via the memory interface 53. Specifically, if the memory management circuit 51 intends to access the rewritable non-volatile memory module 43, the memory interface 53 will send the corresponding command sequence. For example, the command sequences may include the write command sequence instructing to write data, the read command sequence instructing to read data, the erase command sequence instructing to erase data, and corresponding command sequences instructing various memory operations (such as changing a read voltage level and executing a garbage collection (GC) operation). The command sequences are, for example, generated by the memory management circuit 51 and sent to the rewritable non-volatile memory module 43 through the memory interface 53. The command sequences may include one or more signals or data on a bus. The signals or the data may include command codes or program codes. For example, the read command sequence includes information such as a read recognition code and a memory address.

In an exemplary embodiment, the memory control circuit unit 42 further includes an error detecting and correcting circuit 54, a buffer memory 55, and a power management circuit 56.

The error detecting and correcting circuit 54 is coupled to the memory management circuit 51 and is configured to execute error detecting and correcting operations to ensure correctness of data. Specifically, when the memory management circuit 51 receives a write command from the host system 11, the error detecting and correcting circuit 54 generates a corresponding error correcting code (ECC) and/or error detecting code (EDC) for data corresponding to the write command, and the memory management circuit 51 writes the data corresponding to the write command and the corresponding error correcting code and/or error detecting code to the rewritable non-volatile memory module 43. Later, when the memory management circuit 51 reads the data from the rewritable non-volatile memory module 43, the error correcting code and/or the error detecting code corresponding to the data are read at the same time, and the error detecting and correcting circuit 54 executes the error detecting and correcting operations on the read data according to the error correcting code and/or the error detecting code.

The buffer memory 55 is coupled to the memory management circuit 51 and is configured to temporarily store data. The power management circuit 56 is coupled to the memory management circuit 51 and is configured to control the power of the memory storage device 10.

In an exemplary embodiment, the rewritable non-volatile memory module 43 of FIG. 4 may include a flash memory module. In an exemplary embodiment, the memory control circuit unit 42 of FIG. 4 may include a flash memory controller. In an exemplary embodiment, the memory management circuit 51 of FIG. 5 may include a flash memory management circuit.

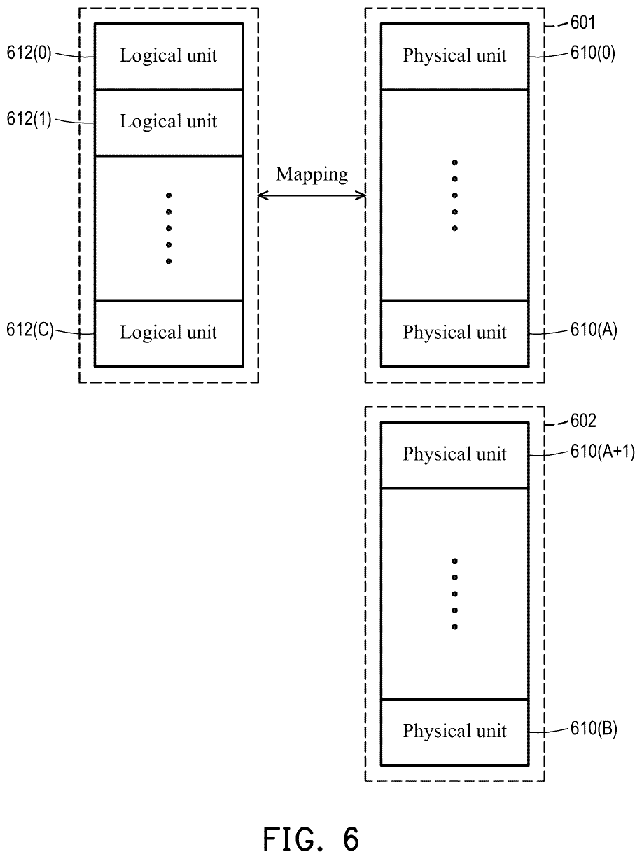

FIG. 6 is a schematic diagram of managing a rewritable non-volatile memory module according to an exemplary embodiment of the disclosure. Please refer to FIG. 6. The memory management circuit 51 may logically group physical units 610(0) to 610(B) in the rewritable non-volatile memory module 43 into a storage area 601 and a spare area 602.

In an exemplary embodiment, a physical unit refers to a physical address or a physical programming unit. In an exemplary embodiment, the physical unit may also be composed of multiple continuous or discontinuous physical addresses. In an exemplary embodiment, the physical unit may also refer to a virtual block (VB). The virtual block may include multiple physical addresses or multiple physical programming units. In an exemplary embodiment, the virtual block may include one or more physical erasing units.

The physical units 610(0) to 610(A) in the storage area 601 are configured to store user data (for example, the user data from the host system 11 of FIG. 1). For example, the physical units 610(0) to 610(A) in the storage area 601 may store valid data and invalid data. The physical units 610(A+1) to 610(B) in the spare area 602 do not store data (for example, valid data). For example, if a certain physical unit does not store valid data, the physical unit may be associated with (or added to) the spare area 602. In addition, the physical units (or the physical units that do not store valid data) in the spare area 602 may be erased. When writing new data, one or more physical units may be extracted from the spare area 602 to store the new data. In an exemplary embodiment, the spare area 602 is also referred to as a free pool.

The memory management circuit 51 may be configured with logical units 612(0) to 612(C) to map the physical units 610(0) to 610(A) in the storage area 601. In an exemplary embodiment, each logical unit corresponds to one logical address. For example, one logical address may include one or more logical block addresses (LBA) or other logical management units. In an exemplary embodiment, one logical unit may also correspond to one logical programming unit or be composed of multiple continuous or discontinuous logical addresses.

It should be noted that one logical unit may be mapped to one or more physical units. If a certain physical unit is currently mapped by a certain logical unit, it means that data currently stored in the physical unit includes valid data. Conversely, if a certain physical unit is not currently mapped by any logical unit, it means that data currently stored in the physical unit is invalid data.

The memory management circuit 51 may record management data (also referred to as logical-to-physical mapping information) describing a mapping relationship between the logical unit and the physical unit in at least one logical-to-physical mapping table. When the host system 11 intends to read data from the memory storage device 10 or write data to the memory storage device 10, the memory management circuit 51 may access the rewritable non-volatile memory module 43 according to information in the logical-to-physical mapping table.

In an exemplary embodiment, the error detecting and correcting circuit 54 may include an encoding circuit 541 and a decoding circuit 542. The encoding circuit 541 is configured to encode data. The decoding circuit 542 is configured to decode data. In an exemplary embodiment, the encoding circuit 541 and the decoding circuit 542 may also be combined into a single encoding/decoding circuit.

In an exemplary embodiment, the error detecting and correcting circuit 54 may support low-density parity-check (LDPC) codes. For example, the error detecting and correcting circuit 54 may decode and encode data using the low-density parity-check codes. Persons skilled in the art should be able to understand how to decode and encode using the low-density parity-check codes, which will not be elaborated here. In another exemplary embodiment, the error detecting and correcting circuit 54 also supports Bose-Chaudhuri-Hocquenghem (BCH) codes, convolutional codes, or turbo codes, but the disclosure is not limited thereto.

In an exemplary embodiment, the error detecting and correcting circuit 54 (or the decoding circuit 542) may decode data read from a physical unit in the rewritable non-volatile memory module 43 to try to correct errors in the data. Assuming that the bit error rate (BER) of the data is not high, the error detecting and correcting circuit 54 (or the decoding circuit 542) may decode the data based on a hard decoding mode to try to quickly correct a small number of errors in the data. Assuming that the bit error rate of the data is high, the error detecting and correcting circuit 54 (or the decoding circuit 542) may decode the data based on a soft decoding mode to improve the decoding success rate of the data. To further illustrate, in the hard decoding mode, the memory management circuit 51 only needs to read a hard bit corresponding to each memory cell from the physical unit, and the error detecting and correcting circuit 54 (or the decoding circuit 542) may perform decoding according to the hard bits. In addition, in the soft decoding mode, the memory management circuit 51 needs to read a hard bit and multiple soft bits corresponding to a single memory cell from the physical unit at the same time, and the error detecting and correcting circuit 54 (or the decoding circuit 542) may perform decoding according to the hard bits and the soft bits.

In general, the soft decoding mode needs to adopt more data (that is, the soft bits) to assist decoding than the hard decoding mode to improve the decoding success rate of the data.

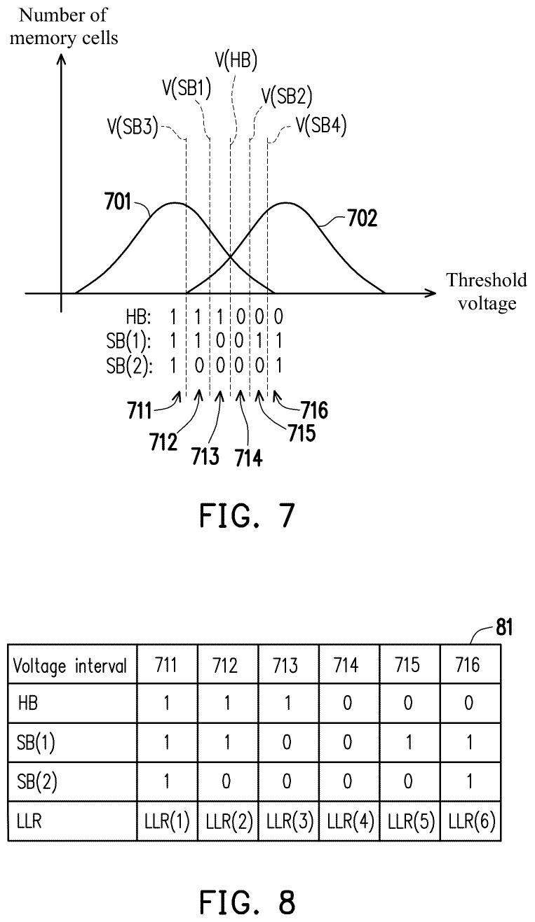

FIG. 7 is a schematic diagram of a threshold voltage distribution of a first physical unit and reading the first physical unit using multiple read voltage levels according to an exemplary embodiment of the disclosure. Please refer to FIG. 7. It is assumed that the first physical unit includes multiple memory cells, and the threshold voltage distributions of the memory cells include statuses 701 and 702. For example, the status 701 corresponds to bit “1” and the status 702 corresponds to bit “0”. That is, if the threshold voltage of a certain memory cell belongs to the status 701, it means that the memory cell is configured to store bit “1”. If the threshold voltage of a certain memory cell belongs to the status 702, it means that the memory cell is configured to store bit “0”. It should be noted that the statuses 701 and 702 may also correspond to other bits or bit combinations, and the disclosure is not limited thereto.

It should be noted that an overlapping region between the status 701 and the status 702 expands along with the degree of usage (or the degree of wear) of the rewritable non-volatile memory module 43, thereby reducing the accuracy of judging whether a certain memory cell belongs to the status 701 or the status 702. For example, when the overlapping region expands, after applying a read voltage level V(HB) to the first physical unit, the threshold voltage of a memory cell originally belonging to the status 701 is greater than the read voltage level V(HB), so the memory cell is misjudged as belonging to the status 702 (that is, a bit stored in the memory cell is misjudged as bit “0”). For example, when the overlapping region expands, after applying the read voltage level V(HB) to the first physical unit, the threshold voltage of a memory cell originally belonging to the status 702 is less than the read voltage level V(HB), so the memory cell is misjudged as belonging to the status 701 (that is, a bit stored in the memory cell is misjudged as bit “1”). At this time, data read from the first physical unit may have a large number of error bits, and the error detecting and correcting circuit 54 (or the decoding circuit 542) may decode the data based on the soft decoding mode, thereby improving the decoding success rate of the data.

In an exemplary embodiment, in the soft decoding mode, the memory management circuit 51 may send at least one read command sequence to the rewritable non-volatile memory module 43. The read command sequence may instruct the rewritable non-volatile memory module 43 to read the data in the first physical unit based on multiple read voltage levels. Specifically, the read voltage levels may include the read voltage level V(HB) and read voltage levels V(SB1) to V(SB4) of FIG. 7. The data read from the first physical unit may include a hard bit HB, a soft bit SB(1), and a soft bit SB(2) of FIG. 7.

In an exemplary embodiment, the rewritable non-volatile memory module 43 may sequentially apply the read voltage level V(HB) and the read voltage levels V(SB1) to V(SB4) to a certain memory cell in the first physical unit to obtain a read result of the memory cell, and return the hard bit HB, the soft bit SB(1), and the soft bit SB(2) to the memory management circuit 51 accordingly. For example, the hard bit HB may reflect the read result of the memory cell using the read voltage level V(HB). If the threshold voltage of the memory cell is lower than the read voltage level V(HB), the rewritable non-volatile memory module 43 may return the hard bit HB with a bit value of “1” to the memory management circuit 51. In contrast, if the threshold voltage of the memory cell is higher than the read voltage level V(HB), the rewritable non-volatile memory module 43 may return the hard bit HB with a bit value of “0” to the memory management circuit 51. Similarly, the soft bit SB(1) and the soft bit SB(2) may reflect read results of the memory cell using the read voltage levels V(SB1) to V(SB4).

In an exemplary embodiment, the read voltage levels V(SB1) to V(SB4) may be divided into multiple voltage intervals 711 to 716. For example, the voltage interval 712 is between the read voltage levels V(SB1) and V(SB3), and so on. The hard bit HB, the soft bit SB(1), and the soft bit SB(2) obtained through reading a certain memory cell may reflect the voltage interval (for example, the voltage interval 712) in which the threshold voltage of the memory cell is located. To further illustrate, assuming that the hard bit HB, the soft bit SB(1), and the soft bit SB(2) obtained through reading a certain memory cell are “110”, it reflects that the threshold voltage of the memory cell is located in the voltage interval 712. The number of the read voltage levels V(SB1) to V(SB4) and the number of the voltage intervals 711 to 716 may be designed according to actual requirements, and the disclosure is not limited thereto.

In an exemplary embodiment, the error detecting and correcting circuit 54 supporting the low-density parity-check codes may execute a decoding operation using reliability information. The reliability information may be, for example, a log likelihood ratio (LLR). Specifically, in the decoding operation, the error detecting and correcting circuit 54 (or the decoding circuit 542) may decode the data read by the memory management circuit 51 using the log likelihood ratio. In another exemplary embodiment, the error detecting and correcting circuit 54 (or the decoding circuit 542) may also execute the decoding operation using other types of reliability information, which is not limited by the disclosure.

In an exemplary embodiment, the greater the absolute value of the log likelihood ratio (which may be positive or negative) corresponding to data (or a bit value), the higher the reliability of the data, that is, the bit value of the data has a high probability of being correct. In contrast, the smaller the absolute value of the log likelihood ratio corresponding to the data, the lower the reliability of the data, that is, the bit value of the data has a high probability of being erroneous. For example, when the log likelihood ratio is 0, it means that the probability of the corresponding data (or bit value) being 0 is the same as the probability of being 1. For example, when the log likelihood ratio is positive and the value is greater, it means that the probability of the corresponding data (or bit value) being 0 is higher. For example, when the log likelihood ratio is negative and the value is smaller, it means that the probability of the corresponding data (or bit value) being 1 is higher. If there is a high probability that the data is erroneous, the decoding circuit 542 may correct the error during the decoding operation, that is, change the bit value of the data. In an exemplary embodiment, the representation range of the log likelihood ratio is determined by the bit width supported by the decoding circuit 542 of the error detecting and correcting circuit 54. Taking the bit width as 5 bits as an example, the representation range of the log likelihood ratio is −15 to +15.

It should be noted that as the usage time and the usage frequency of the rewritable non-volatile memory module 43 increase, variables such as the degrees of wear and the read times and the erase times of the physical units in the rewritable non-volatile memory module 43 are all different. In other words, the reliabilities of the physical units are also different. Therefore, the log likelihood ratios corresponding to data stored in different physical units may be derived from different lookup tables.

FIG. 8 is a schematic diagram of a first lookup table corresponding to a first physical unit according to an exemplary embodiment of the disclosure. Please refer to FIG. 8. A first lookup table 81 may be configured to record the hard bit HB, the soft bit SB(1), the soft bit SB(2), and log likelihood ratios LLR(1) to LLR(6) corresponding to each of the voltage intervals 711 to 716. In an exemplary embodiment, assuming that the bit width supported by the decoding circuit 542 is 5 bits, the representation range of the log likelihood ratios LLR(1) to LLR(6) is −15 to +15.

In an exemplary embodiment, the memory management circuit 51 may update (or adjust) the reliability information (that is, the log likelihood ratio) corresponding to certain data according to a decoding result of the decoding operation on the data.

In an exemplary embodiment, before the memory management circuit 51 writes data to the rewritable non-volatile memory module 43, the data is first encoded to generate corresponding parity data, and the data and the parity data are then stored in the rewritable non-volatile memory module 43. Thereafter, when the memory management circuit 51 intends to read the physical unit, the memory management circuit 51 may read the data in the physical unit and the corresponding parity data. The decoding circuit 542 in the error detecting and correcting circuit 54 may execute the decoding operation according to the data read from the physical unit and the parity data to detect and correct errors in the data.

In an exemplary embodiment, the memory management circuit 51 obtains write data. The encoding circuit 541 may execute an encoding operation according to the write data to generate first parity data and second parity data. In an exemplary embodiment, the second parity data is generated according to the write data and the first parity data. Specifically, the encoding circuit 541 may execute the encoding operation according to the write data to generate the first parity data, and the encoding circuit 541 may execute another encoding operation according to the write data and the first parity data to generate the second parity data. In another exemplary embodiment, the second parity data is not generated according to the first parity data. Specifically, the encoding circuit 541 may include, for example, a first encoding circuit (not shown) and a second encoding circuit (not shown) that operate independently of each other. The first encoding circuit in the encoding circuit 541 may execute a first encoding operation according to the write data to generate the first parity data, and the second encoding circuit in the encoding circuit 541 may execute a second encoding operation according to the write data to generate the second parity data. In addition, the first parity data may be used alone or in combination with the second parity data to perform the decoding operation with the write data. The second parity data cannot be used alone to perform the decoding operation with the write data.

After encoding the write data, the memory management circuit 51 may send a write command sequence (also referred to as a first write command sequence) to the rewritable non-volatile memory module 43. The first write command sequence may be configured to instruct the rewritable non-volatile memory module 43 to store the write data, the first parity data, and the second parity data. In an exemplary embodiment, the memory management circuit 51 may store the write data and the first parity data in the same physical unit (for example, the first physical unit), and store the second parity data in another physical unit (for example, a second physical unit).

In an exemplary embodiment, the encoding circuit 541 may execute the encoding operation according to the write data to generate third parity data. In an exemplary embodiment, the third parity data is generated according to the write data, the first parity data, and the second parity data. Specifically, after the encoding circuit 541 sequentially generates the first parity data and the second parity data, the encoding circuit 541 may execute the encoding operation according to the write data, the first parity data, and the second parity data to generate the third parity data. In another exemplary embodiment, the third parity data is not generated according to the first parity data and the second parity data. Specifically, the encoding operation may also include a third encoding operation. In addition to the first encoding circuit and the second encoding circuit, the encoding circuit 541 may further include a third encoding circuit (not shown). The third encoding circuit in the encoding circuit 541 may execute the third encoding operation according to the write data to generate the third parity data. In addition, the first parity data may be used alone, in combination with the second parity data, or in combination with the second parity data and the third parity data, to perform the decoding operation with the write data. The second parity data needs to be used in combination with the first parity data to perform the decoding operation with the write data. The third parity data needs to be used in combination with the first parity data and the second parity data to perform the decoding operation with the write data.

After encoding the write data, the memory management circuit 51 may send a write command sequence (also referred to as a second write command sequence) to the rewritable non-volatile memory module 43. The second write command sequence may be configured to instruct the rewritable non-volatile memory module 43 to store the write data, the first parity data, the second parity data, and the third parity data. In an exemplary embodiment, the memory management circuit 51 may store the write data and the first parity data in the same physical unit (that is, the first physical unit), and store the second parity data and the third parity data in another physical unit (that is, the second physical unit). In an exemplary embodiment, the second parity data and the third parity data are stored in different physical units, wherein the physical unit for storing the third parity data is also referred to as a third physical unit.

Thereafter, the memory management circuit 51 may send at least one read command sequence to the rewritable non-volatile memory module 43. The read command sequence may instruct the rewritable non-volatile memory module 43 to read data from a specific physical unit. When reading the write data from the rewritable non-volatile memory module 43, the memory management circuit 51 may also read the first parity data (and the second parity data and the third parity data) together from the rewritable non-volatile memory module 43. The decoding circuit 542 may execute the decoding operation according to the first parity data (and the second parity data and the third parity data) and the write data read from the rewritable non-volatile memory module 43 to detect and correct errors in the write data.

It should be noted that when reading the write data from the rewritable non-volatile memory module 43, the memory management circuit 51 may only read the first parity data together, and in the situation where a higher error correction ability is required (that is, the decoding of the first parity data fails), the second parity data (and the third parity data) may be read depending on the decoding situation to improve the decoding speed.

In other words, the error detecting and correcting circuit 54 may execute an iterative decoding operation. The iterative decoding operation is configured to decode one piece of data from the rewritable non-volatile memory module 43. In the iterative decoding operation, a parity-check operation for checking the correctness of the data and the decoding operation for correcting the errors in the data may be repeatedly and alternately executed until decoding is successful or the number of iterations reaches a predetermined number. If the number of iterations reaches the predetermined number, it means that decoding fails. If decoding is successful, the error detecting and correcting circuit 54 may stop the decoding operation, and output successfully decoded data.

In an exemplary embodiment, when reading the write data from the rewritable non-volatile memory module 43, the error detecting and correcting circuit 54 (or the decoding circuit 542) may first decode the write data and the first parity data based on the hard decoding mode using preset reliability information (that is, the log likelihood ratio). If decoding fails, the error detecting and correcting circuit 54 (or the decoding circuit 542) may decode the write data, the first parity data, and the second parity data (and the third parity data) based on the soft decoding mode using the updated (or adjusted) log likelihood ratio instead to improve the decoding success rate.

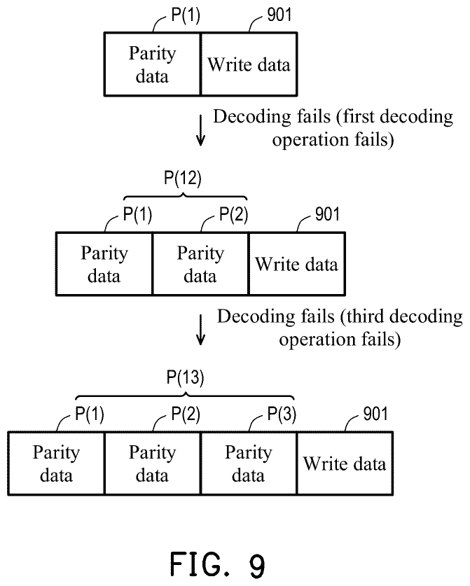

FIG. 9 is a schematic diagram of a decoding process according to an exemplary embodiment of the disclosure. Please refer to FIG. 9. It is assumed that first parity data P(1), second parity data P(2), and third parity data P(3) are all generated by encoding write data 901 stored in the rewritable non-volatile memory module 43. The relevant operation details have been described above and will not be repeated here.

In an exemplary embodiment, the memory management circuit 51 may send a first read command sequence to the rewritable non-volatile memory module 43 to read the write data 901 and the first parity data P(1) from the rewritable non-volatile memory module 43. When the memory management circuit 51 reads the write data 901 and the first parity data P(1) from the rewritable non-volatile memory module 43, the memory management circuit 51 also obtains the log likelihood ratio corresponding to the write data 901 and the log likelihood ratio corresponding to the first parity data P(1). In an exemplary embodiment, the memory management circuit 51 may obtain the log likelihood ratio through looking up a table. Specifically, since the write data 901 and the first parity data P(1) are stored in the same physical unit (that is, the first physical unit), the memory management circuit may obtain the log likelihood ratios corresponding to the write data 901 and the first parity data P(1) from the first lookup table 81 corresponding to the first physical unit. Since the write data 901 and the first parity data P(1) have not been decoded, the memory management circuit 51 may obtain the preset log likelihood ratios from the first lookup table 81.

Thereafter, the error detecting and correcting circuit 54 may execute the decoding operation (also referred to as the first decoding operation) according to the write data 901 and the first parity data P(1). Specifically, the memory management circuit 51 may provide the obtained log likelihood ratios (that is, the log likelihood ratios corresponding to the write data 901 and the first parity data P(1)) to the error detecting and correcting circuit 54. Accordingly, the decoding circuit 542 of the error detecting and correcting circuit 54 may execute the first decoding operation on the write data 901 and the first parity data P(1) using the log likelihood ratios provided by the memory management circuit 51 to improve decoding efficiency.

If decoding is successful (that is, the first decoding operation is successful), the error detecting and correcting circuit 54 may stop the decoding operation, and output the successfully decoded data.

On the other hand, if decoding fails (that is, the first decoding operation fails), the memory management circuit 51 may send a second read command sequence to the rewritable non-volatile memory module 43 to read the second parity data P(2) from the rewritable non-volatile memory module 43. When the memory management circuit 51 reads the second parity data P(2) from the rewritable non-volatile memory module 43, the memory management circuit 51 also obtains the log likelihood ratio corresponding to the second parity data P(2). Specifically, since the second parity data P(2) is stored in a different physical unit (that is, the second physical unit) from the write data 901 (and the first parity data P(1)), the memory management circuit 51 may obtain the log likelihood ratio corresponding to the second parity data P(2) from a second lookup table corresponding to the second physical unit, wherein the second lookup table is different from the first lookup table 81. The contents recorded in the second lookup table are similar to those in the first lookup table 81 and are therefore not repeated here. Since the second parity data P(2) has not been decoded, the memory management circuit 51 may obtain the preset log likelihood ratio from the second lookup table.

Next, the decoding circuit 542 may execute the decoding operation (also referred to as the second decoding operation) according to the second parity data P(2). Specifically, the memory management circuit 51 may provide the obtained log likelihood ratio (that is, the log likelihood ratio corresponding to the second parity data P(2)) to the error detecting and correcting circuit 54. Accordingly, the decoding circuit 542 of the error detecting and correcting circuit 54 may execute the second decoding operation on the second parity data P(2) using the log likelihood ratio provided by the memory management circuit 51 to improve decoding efficiency.

If decoding fails (that is, the second decoding operation fails), the memory management circuit 51 may reduce the log likelihood ratio corresponding to the second parity data P(2). In an exemplary embodiment, the memory management circuit 51 may record a decoding result of the decoding operation (for example, the first decoding operation and/or the second decoding operation), and adjust the log likelihood ratio according to the decoding result. Specifically, since the first decoding operation fails, the memory management circuit 51 may reduce the log likelihood ratio corresponding to the write data 901 and the log likelihood ratio corresponding to the first parity data P(1). Similarly, since the second decoding operation also fails, the memory management circuit 51 may reduce the log likelihood ratio corresponding to the second parity data P(2). Accordingly, the decoding circuit 542 may perform the decoding operation on the write data 901, the first parity data P(1), and the second parity data P(2) using the reduced log likelihood ratios to improve decoding efficiency. It is worth mentioning that through increasing the data length of parity data (that is, parity data P(12) combined from the first parity data P(1) and the second parity data P(2)), the decoding circuit 542 may improve the error correction ability of the write data 901.

On the other hand, if decoding is successful (that is, the second decoding operation is successful), the memory management circuit 51 may increase the log likelihood ratio corresponding to the second parity data P(2). Specifically, the memory management circuit 51 may adjust the log likelihood ratio according to the decoding result. Since the second decoding operation on the second parity data P(2) is successful (that is, the second parity data P(2) is correct), the memory management circuit 51 may increase the log likelihood ratio corresponding to the second parity data P(2) (for example, “1001”) to “−15, +15, +15, −15”. In addition, since the first decoding operation fails, the memory management circuit 51 may reduce the log likelihood ratio corresponding to the write data 901 and the log likelihood ratio corresponding to the first parity data P(1).

Accordingly, the decoding circuit 542 may perform a decoding operation (that is, a third decoding operation) on the write data 901, the first parity data P(1), and the second parity data P(2) using the adjusted log likelihood ratios to improve decoding efficiency.

From the perspective of the decoding circuit 542, the write data 901, the first parity data P(1), and the second parity data P(2) may be regarded as serial data. Assuming that the write data 901 is “1010”, the first parity data P(1) is “1100”, and the second parity data P(2) is “1001”, the serial data is “101011001001”. Since the write data 901 and the first parity data P(1) are stored in the same physical unit (that is, the first physical unit), the write data 901 and the first parity data P(1) may be regarded as a first part of the serial data (that is, the first 8 bits “10101100” of the serial data). Similarly, since the second parity data P(2) is stored in a different physical unit (that is, the second physical unit) from the write data 901 (and the first parity data P(1)), the second parity data P(2) may be regarded as a second part of the serial data (that is, the last 4 bits “1001” of the serial data). That is, the decoding circuit 542 may execute the decoding operation (that is, the third decoding operation) according to the serial data.

In an exemplary embodiment, the decoding circuit 542 may execute the third decoding operation on the first part using a first log likelihood ratio, and execute the third decoding operation on the second part using a second log likelihood ratio. The log likelihood ratios corresponding to the write data 901 and the first parity data P(1) are the first log likelihood ratio, and the log likelihood ratio corresponding to the second parity data P(2) is the second log likelihood ratio. As mentioned above, the log likelihood ratios corresponding to the write data 901 and the first parity data P(1) are derived from the first lookup table 81, and the log likelihood ratio corresponding to the second parity data P(2) is derived from the second lookup table. In other words, the first log likelihood ratio is derived from the first lookup table 81, and the second log likelihood ratio is derived from the second lookup table.

Here, the first part has been decoded and decoding fails (that is, the first decoding operation fails), and the second part has been decoded and decoding is successful (that is, the second decoding operation is successful). The decoding circuit 542 may perform the third decoding operation on the write data 901 and the first parity data P(1) using the reduced first log likelihood ratios, and perform the third decoding operation on second parity data P(2) using the increased second log likelihood ratio to improve decoding efficiency.

If decoding is successful (that is, the third decoding operation is successful), the error detecting and correcting circuit 54 may stop the decoding operation, and output the successfully decoded data.

On the other hand, if decoding fails (that is, the third decoding operation fails), the memory management circuit 51 may send a third read command sequence to the rewritable non-volatile memory module 43 to read the third parity data P(3) from the rewritable non-volatile memory module 43. When the memory management circuit 51 reads the third parity data P(3) from the rewritable non-volatile memory module 43, the memory management circuit 51 also obtains the log likelihood ratio corresponding to the third parity data P(3). Specifically, since the third parity data P(3) is stored in a different physical unit (that is, the third physical unit) from the second parity data P(2) and the write data 901 (and the first parity data P(1)), the memory management circuit 51 may obtain the log likelihood ratio corresponding to the third parity data P(3) from a third lookup table corresponding to the physical unit for storing the third parity data P(3), wherein the third lookup table is different from the first lookup table and the second lookup table. The contents recorded in the third lookup table are similar to those in the first lookup table 81 and are therefore not repeated here.

Next, the decoding circuit 542 may execute a decoding operation (also referred to as a fourth decoding operation) according to the third parity data P(3). Specifically, the decoding circuit 542 of the error detecting and correcting circuit 54 may execute the fourth decoding operation on the third parity data P(3) using the log likelihood ratio corresponding to the third parity data P(3) to improve decoding efficiency.

If decoding fails (that is, the fourth decoding operation fails), the memory management circuit 51 may reduce the log likelihood ratio corresponding to the third parity data P(3). In an exemplary embodiment, the memory management circuit 51 may record a decoding result of the decoding operation, and adjust the log likelihood ratio accordingly. Specifically, since the third decoding operation fails, the memory management circuit 51 reduces the log likelihood ratio corresponding to the write data 901 and the log likelihood ratio corresponding to the first parity data P(1) again. Similarly, since the fourth decoding operation also fails, the memory management circuit 51 may reduce the log likelihood ratio corresponding to the third parity data P(3). Accordingly, the decoding circuit 542 may perform the decoding operation on the write data 901, the first parity data P(1), the second parity data P(2), and the third parity data P(3) using the reduced log likelihood ratios to improve decoding efficiency. Here, the decoding circuit 542 may combine the first parity data P(1), the second parity data P(2), and the third parity data P(3) into parity data P(13), and execute the decoding operation according to the write data 901 and the parity data P(13) to improve the error correction ability of the write data 901.

On the other hand, if decoding is successful (that is, the fourth decoding operation is successful), the memory management circuit 51 may increase the log likelihood ratio corresponding to the third parity data P(3). Taking the representation range of the log likelihood ratio as −15 to +15 as an example, assuming that the third parity data P(3) is “1010”, the log likelihood ratio corresponding to the third parity data P(3) is “−15, +15, −15, +15”. In addition, since the third decoding operation fails, the memory management circuit 51 reduces the log likelihood ratio corresponding to the write data 901 and the log likelihood ratio corresponding to the first parity data P(1) again.

Accordingly, the decoding circuit 542 may perform a decoding operation (that is, a fifth decoding operation) on the write data 901, the first parity data P(1), the second parity data P(2), and the third parity data P(3) using the adjusted log likelihood ratios to improve decoding efficiency. It is worth mentioning that the decoding circuit 542 may combine the first parity data P(1), the second parity data P(2), and the third parity data P(3) into the parity data P(13) with a longer data length, and execute the fifth decoding operation according to the write data 901 and the parity data P(13) to improve the error correction ability of the write data 901.

Regarding the subsequent operations after the fifth decoding operation is successful or fails, reference may be, for example, made to the subsequent operations after the third decoding operation is successful or fails, which will not be elaborated here.

It should be noted that in an exemplary embodiment, if the third decoding operation fails, the memory management circuit 51 may not adjust the log likelihood ratio corresponding to the write data 901 and the log likelihood ratio corresponding to the first parity data P(1). In other words, the memory management circuit 51 may also only adjust (that is, increase) the log likelihood ratio of the successfully decoded data, thereby improving decoding ability.

It should be noted that FIG. 9 takes the parity data P(1) to P(3) as an example. In an exemplary embodiment, the encoding circuit 541 may further perform more encoding operations on the write data 901 to generate more parity data. Accordingly, when subsequently decoding the write data 901, in response to decoding failing, more parity data may be configured to extend the parity data P(1) to effectively improve the decoding success rate of the write data 901.

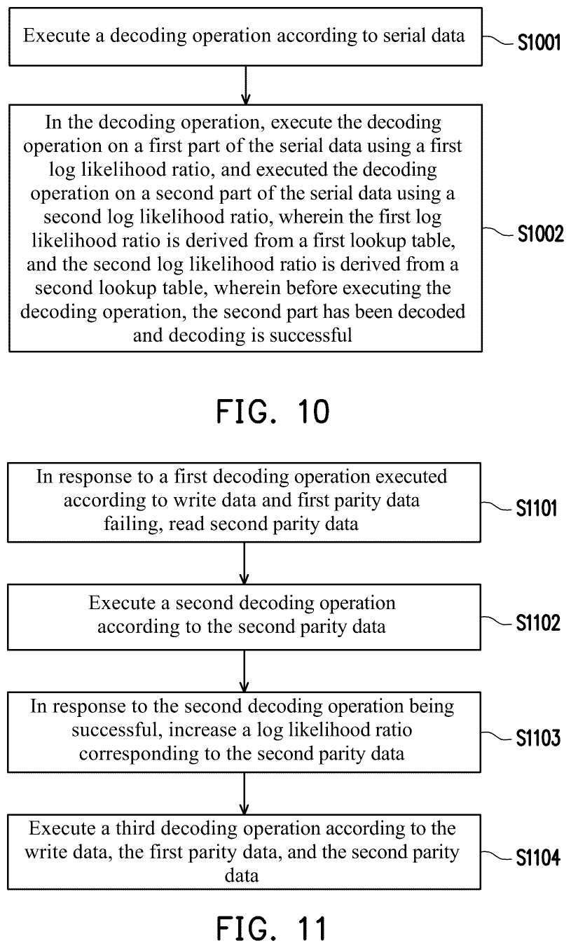

FIG. 10 is a flowchart of a decode control method according to an exemplary embodiment of the disclosure. Please refer to FIG. 10. In step S1001, a decoding operation is executed according to serial data. In step S1002, in the decoding operation, the decoding operation is executed on a first part of the serial data using a first log likelihood ratio, and the decoding operation is executed on a second part of the serial data using a second log likelihood ratio, wherein the first log likelihood ratio is derived from a first lookup table, and the second log likelihood ratio is derived from a second lookup table, wherein before executing the decoding operation, the second part has been decoded and decoding is successful.

FIG. 11 is a flowchart of a decode control method according to an exemplary embodiment of the disclosure. Please refer to FIG. 11, in step S1101, in response to a first decoding operation executed according to write data and first parity data failing, second parity data is read. In step S1102, a second decoding operation is executed according to the second parity data. In step S1103, in response to the second decoding operation being successful, a log likelihood ratio corresponding to the second parity data is increased. In step S1104, a third decoding operation is executed according to the write data, the first parity data, and the second parity data.

However, each step in FIG. 10 and FIG. 11 has been described in detail above and will not be repeated here. It should be noted that each step in FIG. 10 and FIG. 11 may be implemented as multiple program codes or circuits, and the disclosure is not limited thereto. In addition, the methods of FIG. 10 and FIG. 11 may be used in conjunction with the above exemplary embodiments or may be used alone, and the disclosure is not limited thereto.

In summary, in the exemplary embodiments of the disclosure, by recording the decoding result of each decoding operation, and dynamically adjusting the reliability information (that is, the log likelihood ratio) according to the decoding result, decoding ability may be effectively improved. In addition, in the exemplary embodiments of the disclosure, multiple parity data may also be stored in different physical units, so as to improve decoding ability according to the characteristic that different physical units have different reliabilities.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A decode control method for a rewritable non-volatile memory module, the decode control method comprising:
in response to a first decoding operation executed according to write data and first parity data failing, reading second parity data;
executing a second decoding operation according to the second parity data;
in response to the second decoding operation being successful, increasing a log likelihood ratio corresponding to the second parity data; and
executing a third decoding operation according to the write data, the first parity data, and the second parity data.

2. The decode control method according to claim 1, further comprising:
in response to the first decoding operation failing, reducing a log likelihood ratio corresponding to the write data and a log likelihood ratio corresponding to the first parity data.

3. The decode control method according to claim 1, further comprising:
in response to the third decoding operation failing, reading third parity data;
executing a fourth decoding operation according to the third parity data;
in response to the fourth decoding operation being successful, increasing a log likelihood ratio corresponding to the third parity data; and
executing a fifth decoding operation according to the write data, the first parity data, the second parity data, and the third parity data.

4. The decode control method according to claim 1, further comprising:
recording decoding results of the first decoding operation and the second decoding operation; and
adjusting the log likelihood ratio according to the decoding result.

5. A decode control method for a rewritable non-volatile memory module, the decode control method comprising:
executing a decoding operation according to serial data;
in the decoding operation, executing the decoding operation on a first part of the serial data using a first log likelihood ratio, and executing the decoding operation on a second part of the serial data using a second log likelihood ratio,
wherein the first log likelihood ratio is derived from a first lookup table, and the second log likelihood ratio is derived from a second lookup table,
wherein before executing the decoding operation, the second part has been decoded and decoding is successful.

6. The decode control method according to claim 5, wherein before executing the decoding operation, the first part has been decoded and decoding fails.

7. The decode control method according to claim 5, wherein the first part and the second part are read from different physical units.

8. A memory storage device, comprising:
a connection interface unit, coupled to a host system;
a rewritable non-volatile memory module; and
a memory control circuit unit, coupled to the connection interface unit and the rewritable non-volatile memory module,
wherein the memory control circuit unit is configured to:
in response to a first decoding operation executed according to write data and first parity data failing, read second parity data; and
in response to a second decoding operation being successful, increase a log likelihood ratio corresponding to the second parity data,
wherein the memory control circuit unit comprises a decoding circuit, and the decoding circuit is configured to:
execute the second decoding operation according to the second parity data; and
execute a third decoding operation according to the write data, the first parity data, and the second parity data.

9. The memory storage device according to claim 8, wherein the memory control circuit unit is further configured to:
in response to the first decoding operation failing, reduce a log likelihood ratio corresponding to the write data and a log likelihood ratio corresponding to the first parity data.

10. The memory storage device according to claim 8, wherein the memory control circuit unit is further configured to:
in response to the third decoding operation failing, read third parity data; and
in response to a fourth decoding operation being successful, increase a log likelihood ratio corresponding to the third parity data, and the decoding circuit is further configured to:
execute the fourth decoding operation according to the third parity data; and
execute a fifth decoding operation according to the write data, the first parity data, the second parity data, and the third parity data.

11. The memory storage device according to claim 8, wherein the memory control circuit unit is further configured to:
record decoding results of the first decoding operation and the second decoding operation; and
adjust the log likelihood ratio according to the decoding result.

12. A memory storage device, comprising:
a connection interface unit, coupled to a host system;
a rewritable non-volatile memory module; and
a memory control circuit unit, coupled to the connection interface unit and the rewritable non-volatile memory module, wherein
the memory control circuit unit comprises a decoding circuit, and the decoding circuit is configured to:
execute a decoding operation according to serial data; and
in the decoding operation, execute the decoding operation on a first part of the serial data using a first log likelihood ratio, and execute the decoding operation on a second part of the serial data using a second log likelihood ratio,
wherein the first log likelihood ratio is derived from a first lookup table, and the second log likelihood ratio is derived from a second lookup table,
wherein before executing the decoding operation, the second part has been decoded and decoding is successful.

13. The memory storage device according to claim 12, wherein before executing the decoding operation, the first part has been decoded and decoding fails.

14. The memory storage device according to claim 12, wherein the first part and the second part are read from different physical units.

15. A memory control circuit unit, configured to control a rewritable non-volatile memory module, the memory control circuit unit comprising:
a host interface, coupled to a connection interface unit;
a memory interface, coupled to the rewritable non-volatile memory module;
a decoding circuit; and
a memory management circuit, coupled to the host interface, the memory interface, and the decoding circuit,
wherein the memory management circuit is configured to:
in response to a first decoding operation executed according to write data and first parity data failing, read second parity data; and
in response to a second decoding operation being successful, increase a log likelihood ratio corresponding to the second parity data,
wherein the decoding circuit is configured to:
execute the second decoding operation according to the second parity data; and
execute a third decoding operation according to the write data, the first parity data, and the second parity data.

16. The memory control circuit unit according to claim 15, wherein the memory management circuit is further configured to:
in response to the first decoding operation failing, reduce a log likelihood ratio corresponding to the write data and a log likelihood ratio corresponding to the first parity data.

17. The memory control circuit unit according to claim 15, wherein the memory management circuit is further configured to:
in response to the third decoding operation failing, read third parity data; and
in response to a fourth decoding operation being successful, increase a log likelihood ratio corresponding to the third parity data,
and the decoding circuit is further configured to:
execute the fourth decoding operation according to the third parity data; and
execute a fifth decoding operation according to the write data, the first parity data, the second parity data, and the third parity data.

18. The memory control circuit unit according to claim 15, wherein the memory management circuit is further configured to:
record decoding results of the first decoding operation and the second decoding operation; and
adjust the log likelihood ratio according to the decoding result.

19. A memory control circuit unit, configured to control a rewritable non-volatile memory module, the memory control circuit unit comprising:
a host interface, coupled to a connection interface unit;
a memory interface, coupled to the rewritable non-volatile memory module;
a decoding circuit; and
a memory management circuit, coupled to the host interface, the memory interface, and the decoding circuit,
wherein the decoding circuit is configured to:
execute a decoding operation according to serial data; and
in the decoding operation, execute the decoding operation on a first part of the serial data using a first log likelihood ratio, and execute the decoding operation on a second part of the serial data using a second log likelihood ratio,
wherein the first log likelihood ratio is derived from a first lookup table, and the second log likelihood ratio is derived from a second lookup table,
wherein before executing the decoding operation, the second part has been decoded and decoding is successful.

20. The memory control circuit unit according to claim 19, wherein before executing the decoding operation, the first part has been decoded and decoding fails.

21. The memory control circuit unit according to claim 19, wherein the first part and the second part are read from different physical units.
